(19) United States
(12) Patent Application Publication
(10) Pub. No.: US 2007/0138323 A1
(43) Pub. Date: Jun. 21, 2007

(54) Drip irrigation hose

(75) Inventor: Chong-Won Lee, Seoul (KR)

Correspondence Address: ARENT FOX PLLC, 1050 CONNECTICUT AVENUE, N.W., SUITE 400, WASHINGTON, DC, 20036, US

(73) Assignee: SEO WON CO., LTD.

(21) Appl. No.: 11/492,763

(22) Filed: Jul. 26, 2006

(30) Foreign Application Priority Data
Dec. 16, 2005 (KR) 2005-0124446

(51) Int. Cl. B05B 15/00

(52) U.S. Cl. 239/542

(57) ABSTRACT

The present invention relates to a drip irrigation hose including: a plurality of unit pressure-reducing channels each secured to the inner wall of the hose at longitudinally-spaced locations along a length of the hose in such a manner as to form an integrated type pressure-reducing channel; and a plurality of outlets for discharging water at longitudinally-spaced locations along the length of the hose, each of the plurality of unit pressure-reducing channels comprising an inlet part having a plurality of inlets formed at the left and right sides thereof, an inducing groove part connected to the inlet part and having a plurality of flow passageways formed in such a manner as to be reduced and enlarged in turn in the width thereof and a plurality of crescent-shaped protrusions formed in the flow passageways enlarged in the width thereof for reducing water pressure while the water flowing thereinto collides therewith, and a staying groove part connected to the inducing groove part and having a large space formed for making water flowing from the inducing groove part stay at stable pressure for a short time of period just before the water is discharged through each of the plurality of outlets to the outside of the hose.

### BACKGROUND OF THE INVENTION

1. Field of the Invention

The present invention relates to a drip irrigation hose wherein a given quantity of water is continuously supplied drop by drop within a predetermined length of the hose to all kinds of crops or landscape trees and plants, and more particularly, to a drip irrigation hose that is provided with a plurality of unit pressure-reducing channels each secured along the length of the hose to the inner wall of the hose in such a manner as to form an integrated type pressure-reducing channel.

2. Background of the Related Art

In general, in the farms where crops like vegetables and garden plants like flowers, garden trees, and fruit trees are grown, water necessarily needed for growing them is supplied by using a hose better than a sprinkler in view of the economical saving and the growing effects of the crops and plants, and before supplied to the crops or plants, at this time, water is sufficiently reduced in pressure such that it dews and drops to the crops and plants.

So as to reduce the water pressure, the pressure-reducing principles using a double hose, a teeth type flow passageway, or a maze type flow passageway are used in the conventional practices.

The double hose, as shown in FIG. 9a, is comprised of a main hose 33 and a branch hose 31 connected to each other, and in this case, after water is full in the main hose 33, the water is supplied to the branch hose 31 through a plurality of fine water holes 35 and is thus reduced in pressure, such that the pressure-reduced water is discharged through a plurality of water discharging holes 30 to the outside.

The teeth type flow passageway, as shown in FIG. 9b, is formed like two teeth spaced apart by a given distance in parallel to each other, such that as the water passes through a plurality of sharp curves formed by the two teeth, it is reduced in pressure.

The maze type flow passageway, as shown in FIG. 9c, is formed such that water passes through a plurality of sharp curves formed by the maze type flow passageway, thereby reducing the pressure of water. This is embodied by using the principle where a vehicle cannot be driven at a fast speed on a road with sharp curves thereon, and in this case, the longer the hose is, the lower the water pressure is and the smaller the quantity of water supply is.

Further, in a structure wherein water after passing through the teeth type flow passageway or the maze type flow passageway is discharged through the water discharging holes, the pressure-reducing effect is obtained only by the process of changing the water flowing direction, such that there occur some problems in that the pressure-reducing effect is not really good and the length of the flow passageway should be extended excessively.

According to the conventional practices, the length of the drip irrigation hose becomes long such that the pressure drop of water is high, which makes it difficult to maintain the water discharging state uniformly along the entire length of the hose.

### SUMMARY OF THE INVENTION

Accordingly, the present invention has been made in view of the above-mentioned problems occurring in the prior art, and it is an object of the present invention to provide a drip irrigation hose that is configured to have a plurality of unit pressure-reducing channels each secured to the inner wall of the hose at longitudinally-spaced locations along a length of the hose in such a manner as to form an integrated type pressure-reducing channel, and to have a plurality of outlets for discharging water at longitudinally-spaced locations along the length of the hose, each of the plurality of unit pressure-reducing channels comprising an inlet part for flowing water into each of the unit pressure-reducing channels, an inducing groove part for sufficiently reducing the pressure of the water flowing through the inlet part, and a staying groove part for making water flowing from the inducing groove part stay for a short time of period just before water is discharged through a hose outlet to the outside of the hose.

To accomplish the above object, according to the present invention, there is provided a drip irrigation hose including: a plurality of unit pressure-reducing channels each secured to the inner wall of the hose at longitudinally-spaced locations along a length of the hose in such a manner as to form an integrated type pressure-reducing channel; and a plurality of outlets for discharging water at longitudinally-spaced locations along the length of the hose, each of the plurality of unit pressure-reducing channels comprising an inlet part having a plurality of inlets formed at the left and right sides thereof, an inducing groove part connected to the inlet part and having a plurality of flow passageways formed in such a manner as to be reduced and enlarged in turn in the width thereof and a plurality of crescent-shaped protrusions formed in the flow passageways enlarged in the width thereof for reducing water pressure while the water flowing thereinto collides therewith, and a staying groove part connected to the inducing groove part and having a large space formed therein for making water flowing from the inducing groove part stay at stable pressure for a short time of period just before the water is discharged through each of the plurality of outlets to the outside of the hose.

That is, so as to improve the pressure-reducing effect of water in the interior of the hose, each of the plurality of unit pressure-reducing channels has the plurality of flow passageways formed in turn reduced and enlarged in their width.

The inducing groove part has a crescent-shaped protrusion formed at each of the flow passageways enlarged in width, such that the water pressure is low while the protrusion is colliding against the water flowing thereinto, and thus, the water is effectively reduced in pressure while passing through the inducing groove part. To conveniently implement the manufacturing process of the drip irrigation hose, the plurality of unit pressure-reducing channels each having the inlet part, the inducing groove part and the staying groove part are disposed at longitudinally-spaced locations along the length of the hose.

Therefore, the water flowing into the hose flows through the inlet part of each of the plurality of unit pressure-reducing channels and flows to the inducing groove part fluidically communicating with the inlet part, such that after the water pressure is greatly reduced and the flowing speed is greatly low, the water stays in the staying groove part. Then, the water staying in the staying groove part drops to plants through the outlet on the hose.

According to the present invention, the irrigation uniformity coefficients are excellent with reference to the plants growing in a large area, at an expense of relatively low installation costs, without consuming any separate personnel costs, thereby achieving efficient water supply results, and further, the quantity of water and the power consumption costs are all reduced, thereby greatly improving the economic savings while growing the plants.

Additionally, since the plurality of unit pressure-reducing channels each including the inlet part, the inducing groove part and the staying groove part are disposed at longitudinally-spaced locations along the length of the hose, water flowing into the inducing groove part through the inlet part is sufficiently reduced in pressure through the flow passageways thereof and then drops to plants, and since the pressure drop of water is not almost generated until the water flows into the inlet parts of the plurality of unit pressure-reducing channels, the water supplying state to each of the plurality of unit pressure-reducing channels is relatively uniform thereto even though the hose is long.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing the external appearance of a drip irrigation hose according to the present invention;

FIG. 2 is a plan view showing an integrated type pressure-reducing channel as a main part of the drip irrigation hose according to a first embodiment of the present invention;

FIG. 3 is a back perspective view showing the integrated type pressure-reducing channel as a main part of the drip irrigation hose according to the first embodiment of the present invention;

FIG. 4 is a sectional view taken along the line A-A of FIG. 2;

FIG. 5 is a sectional view taken along the line B-B of FIG. 2;

FIG. 6 is a plan view showing an integrated type pressure-reducing channel as a main part of the drip irrigation hose according to a second embodiment of the present invention;

FIG. 7 is a plan view showing an integrated type pressure-reducing channel as a main part of the drip irrigation hose according to a third embodiment of the present invention;

FIG. 8 is a plan view showing an inducing groove part separated from the unit pressure-reducing channel of FIG. 2; and

FIG. 9 is a plan view showing a pressure-reducing channel of a conventional drip irrigation hose.

### DETAILED DESCRIPTION OF THE PREFERRED EMBODIMENT

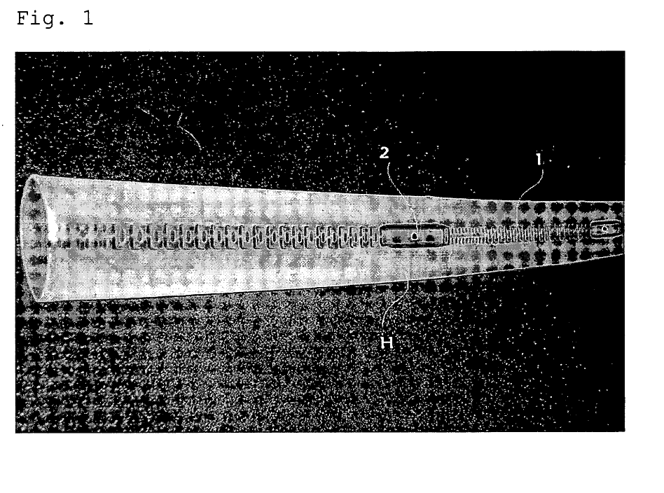

FIG. 1 is a perspective view showing the external appearance of a drip irrigation hose according to the present invention, wherein the drip irrigation hose according to the present invention is a hose H having a cylindrical or oval section and includes an integrated type pressure-reducing channel 1 secured at the upper portion of the inner wall of the hose H along the entire length of the hose H.

The integrated type pressure-reducing channel 1 can be easily made in such a manner as to be melted on the inner wall of the hose H during the drawing process of the hose H, without having any additional process.

Another coupling method of the integrated type pressure-reducing channel 1 with the hose H may be adopted, but since the hose H and the integrated type pressure-reducing channel 1 are made of a synthetic resin, the melting method is most effective.

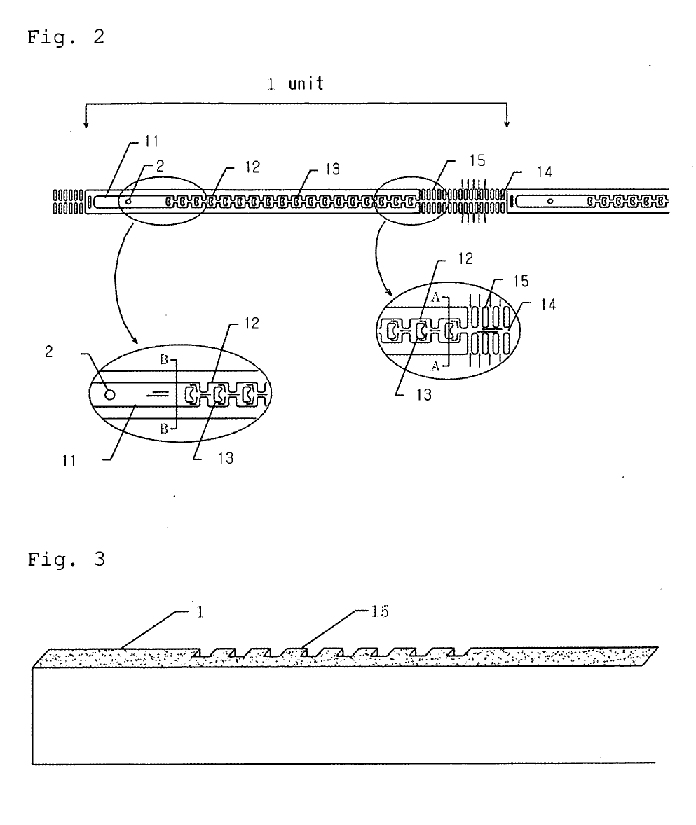

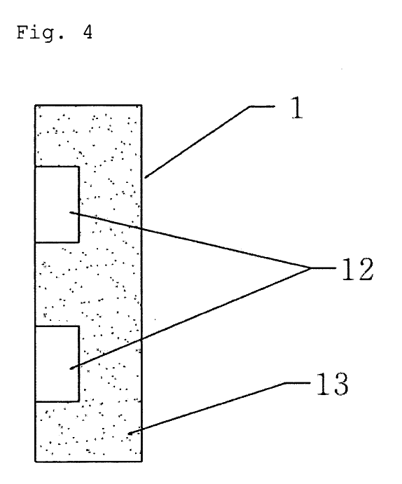

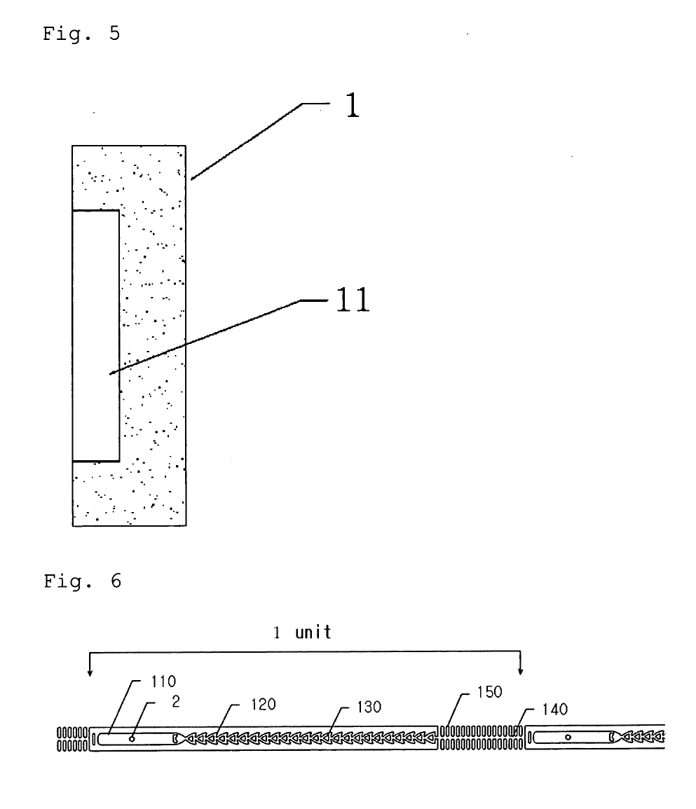

FIG. 2 is a plan view showing an integrated type pressure-reducing channel as a main part of the drip irrigation hose according to a first embodiment of the present invention, FIG. 3 is a back perspective view showing the integrated type pressure-reducing channel as a main part of the drip irrigation hose according to the first embodiment of the present invention, FIG. 4 is a sectional view taken along the line A-A of FIG. 2, and FIG. 5 is a sectional view taken along the line B-B of FIG. 2. In this embodiment, the integrated type pressure-reducing channel 1 has a plurality of unit pressure-reducing channels disposed at longitudinally-spaced locations along the length of the hose H, each of the plurality of unit pressure-reducing channels having an inlet part 14 having a plurality of inlets 15 formed at the left and right sides thereof, an inducing groove part 12 connected to the inlet part 14 and having a plurality of flow passageways formed in turn reduced and enlarged in width for reducing the pressure of water flowing through the inlet part 14, the inducing groove part 12 having a protrusion 13 formed at each of the flow passageways enlarged in width such that the water pressure is low while the protrusion 13 is colliding against the water flowing thereinto, and a staying groove part 11 connected to the inducing groove part 12 and having a large space formed for making water flowing from the inducing groove part 12 stay at stable pressure for a short time of period just.

Further, the hose H has a plurality of outlets 2 formed at the positions of corresponding with the staying groove parts 11 of the unit pressure-reducing channels for discharging water to the outside of the hose H, and since the plurality of unit pressure-reducing channels each having the inlet part 14, the inducing groove part 12 and the staying groove part 11 are disposed at longitudinally-spaced locations along the length of the hose H, the plurality of outlets 2 are also disposed at longitudinally-spaced locations along the length of the hose H.

On the other hand, as shown in FIG. 3, since the integrated type pressure-reducing channel 1 is closed entirely except that the plurality of inlets 15 formed at the left and right sides of the inlet part 14, water is supplied only through the inlets 15 of the inlet part 14 and is also discharged only through the inducing groove part 12 fluidically communicating with the inlet part 14 and the staying groove part 11 to the outside of the hose H.

Also, since the plurality of inlets 15 are formed at the side walls of the inlet part 14, the drip irrigation hose has a filtering function of preventing the clogging of the hose unlike the inlet parts of existing pressure-reducing channels, and as a result, even though the clogging occurs, the operation of the drip irrigation hose is good.

As shown in FIG. 2, the water flowing into the inducing groove part 12 is effectively reduced in pressure via the plurality of flow passageways formed in turn reduced and enlarged in width and via the crescent-shaped protrusions 13 formed in the flow passageways enlarged in width.

In the embodiment of the present invention as shown in FIG. 2, since the square flow passageways enlarged in width are connected with the flow passageways reduced drastically in width, the water flowing from the inlet part 14 is passed through the plurality of flow passageways repeatedly reduced and enlarged in width to form turbulent flow resulting in the reduction of water pressure. Especially, the wall surface of the protrusion 13 is crescent-shaped for the purpose of facilitating the formation of turbulent flow when water collides with the protrusion 13, such that even when the water colliding with the protrusion 12 is mixed with the water that does not collide therewith, another turbulent flow is formed, thereby obtaining excellent pressure-reducing effects.

According to a unique feature of the present invention, the structure of flow passageways in the inducing groove part 12 of each of the plurality of unit pressure-reducing channels is completely different from those in the prior arts.

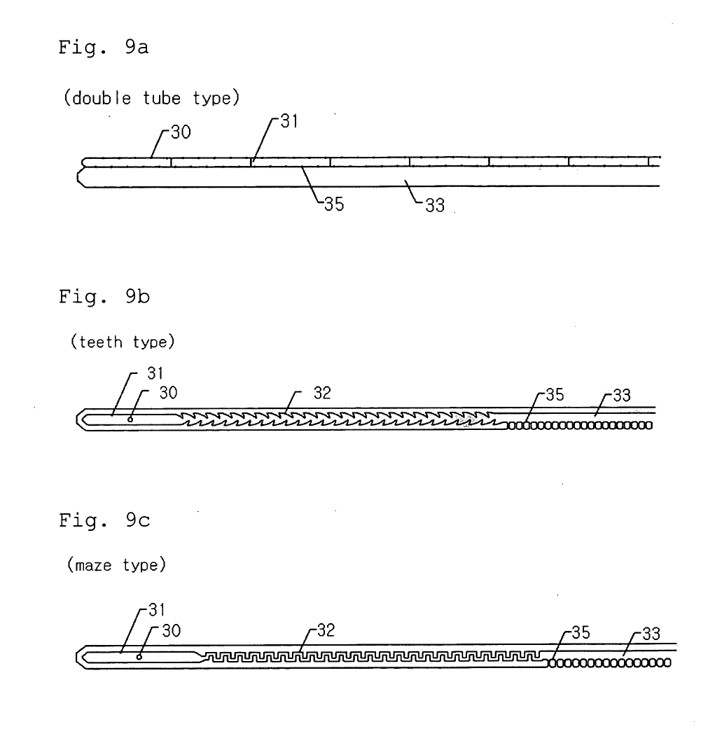

FIG. 8 is a plan view showing an inducing groove part separated from the pressure-reducing channel of FIG. 2.

Since water should fall in drops from the plurality of outlets 2 in the drip irrigation hose H, the water in the staying groove part 11 fluidically communicating with the outlet 2 has to be sufficiently reduced to pressure approximating atmospheric pressure.

The water is reduced in pressure by the internal friction force caused by the viscosity thereof while flowing via the hose, and in this case, the internal friction force is proportional to the internal area of the hose contacting with water and the length of the hose, but it is inversely proportional to the diameter of the hose.

Also, the pressure-reducing effect is lowest at laminar flow, but it is highest at high degree of turbulent flow (high Reynolds number).

At the inducing groove part 12 in the drip irrigation hose of this invention, as shown in FIG. 8, the water flowing through the linear flow passageways reduced in width collides with the protrusions 13 and is divided into left and right flow. Then, the left and right flow is met at the rear side thereof, and at this time, the water flowing from the different directions collides to momentarily make the flow flux of a value 0, thereby obtaining excellent pressure-reducing effects.

In more detail, an explanation of the pressure-reducing process will be given below with reference to FIG. 8.

A position I is the leading position of the inducing groove part 12 to which water like laminar flow flows, and after the flowing water collides with the protrusion 13, the water is curved to the left and right sides by 90°. At this time, the water curved from the protrusion 13 after colliding with the protrusion 13 and the water flowing newly are mixed to form turbulent flow, and as the flow passageways are curved two times by 90°, the internal friction force becomes great.

On the other hand, positions II and II′ are the intermediate positions of the inducing groove part 12, wherein the water that is divided into two flow streams advances at the same speed and is curved inwardly by 90°, and at this time, as the flow passageways are curved, in the same manner as above, the friction force becomes great.

A position III is the position where the water flowing from different directions collides and mixes, and in this case, since the two flow passageways have the same diameter as each other, the colliding water has the same flow flux and the opposite flow directions, such that as the flow flux is a value of 0 at a time of colliding water from the two flow passageways and as the water particles are strongly mixed in every direction, the internal friction force at this position III is stronger than that at the different positions, and most of pressure-reducing effects are generated at this position III.

A position IV is the position where the mixed water flows along the linear flow passageway, and the water that is greatly reduced in pressure after passing through the position III is passed through the position IV and supplied to another position I. In this case, the above-mentioned process is carried out repeatedly, thereby achieving better pressure-reducing effects.

Further, according to the present invention, since the better pressure-reducing effects are obtained when compared with the conventional practices by the unique internal structure of the inducing groove part 12 of the drip irrigation hose of this invention, the length of the inducing groove part 12 of this invention may be relatively shorter than that of the conventional practices, and even in this case, of course, the same pressure-reducing effects as the conventional practices can be achieved.

Therefore, the plurality of unit pressure-reducing channels each having the inlet part 14, the inducing groove part 12 and the staying groove part 11 can be advantageously disposed at narrower intervals than those in the conventional practices, and the reduction of the water pressure is mostly conducted through the inducing groove part 12, not through the inlet part 14, such that even though the hose is extended further, the water pressure acting at the inlet part 14 of each unit pressure-reducing channel is almost the same as another inlet part 12. Thus, a uniform quantity of water can be continuously supplied irrespective of the length of the hose H.

On the other hand, the water reduced in pressure through the inducing groove part 12 flows to the staying groove part 11 having a relatively large container like a reservoir, thereby making the reduced water pressure stabilized.

In this case, since the staying groove part 11 fluidically communicates with the outlet 2 of the hose H, the water in the staying groove part 11 is discharged through the outlet 2. At this time, the water is discharged after the water pressure has been stabilized, such that it can continuously drop like dew.

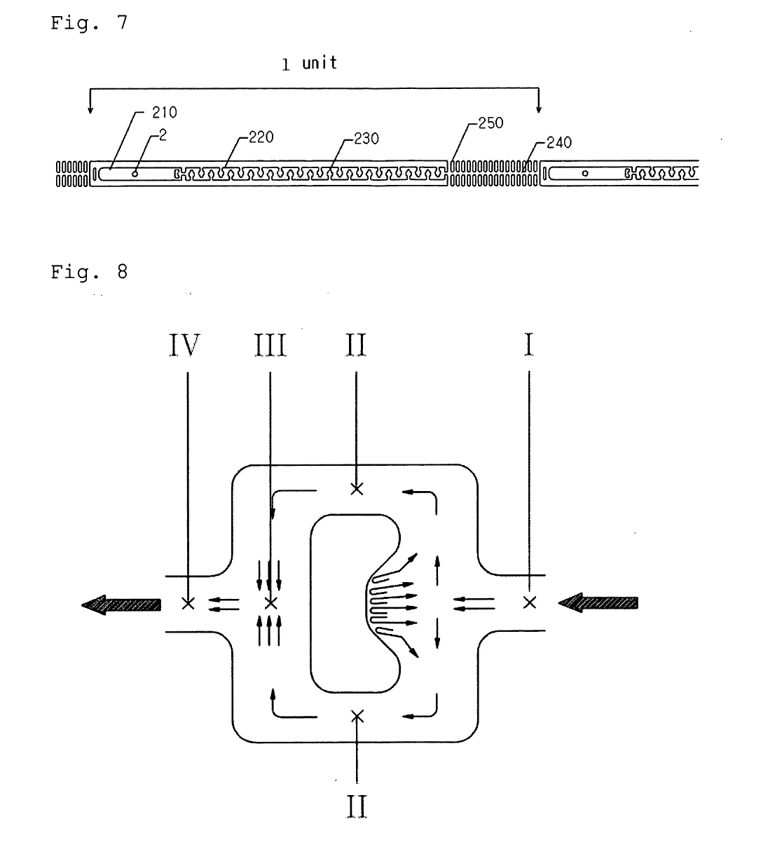

FIG. 6 is a plan view showing an integrated type pressure-reducing channel as a main part of the drip irrigation hose according to a second embodiment of the present invention, and FIG. 7 is a plan view showing an integrated type pressure-reducing channel as a main part of the drip irrigation hose according to a third embodiment of the present invention.

Referring first to FIG. 6, in the components of an integrated type pressure-reducing channel 100, the configurations of an inlet part 140 and a staying groove part 110 are the same as those in the embodiment as shown in FIG. 2, except an inducing groove part 120.

Each of crescent-shaped flow passageways is gently reduced in width from the inlet to the outlet, such that the pressure drop is gradually generated, and the plurality of crescent-shaped flow passageways are connected to one another along the length of the hose, such that the pressure drop is generated repeatedly and the turbulent flow is naturally formed.

Furthermore, each of the plurality of crescent-shaped flow passageways has a protrusion 130, and the turbulent flow is formed when water collides with the protrusion 130. Next, another turbulent flow is formed when the water colliding with the protrusion 130 is mixed with water flowing newly, thereby achieving excellent pressure-reducing effects.

Referring next to FIG. 7, in the components of an integrated type pressure-reducing channel 200, the configurations of an inlet part 240 and a staying groove part 210 are the same as those in the embodiment as shown in FIG. 2, except an inducing groove part 220.

That is to say, the inducing groove part 220 is formed in such a manner as to be reduced and enlarged in turn in the width thereof by the formation of a plurality of protrusions 230 disposed at equally-spaced locations along the length of the hose, and the plurality of protrusions 230 are located in the middle portions of the flow passageways for producing the turbulent flow when water collides thereaginst.

In other words, the plurality of protrusions 230 are arranged to left and right sides in turn to form a maze-like arrangement and in the middle portions of the protrusions 230 are provided round head-like protrusions 231 for generating turbulent flow when water collides therewith.

In this case, the water flowing through the inducing groove part 120 or 220 is sent to the staying groove part 110 or 210 where the water pressure is stabilized, and since the staying groove part 110 or 210 fluidically communicates with the outlet 2 of the hose H, the water in the staying groove part 110 or 210 is discharged through the outlet 2. At this time, the water is discharged after the water pressure has been stabilized, such that it can continuously drop like dew.

Now, an explanation of the operating method and performance of the drip irrigation hose according to the present invention is given below with reference to the experiment results obtained when compared with the conventional drip irrigation hose as shown in FIG. 9.

FIG. 9 is a plan view showing a pressure-reducing channel of a conventional drip irrigation hose, wherein a reference numeral 30 denotes an outlet, 31 denotes a staying groove part, 32 denotes an inducing groove part, 33 denotes an inlet part, and 35 denotes an inlet.

To compare the pressure-reducing characteristics and the discharging flow rates in the respective hoses, while the water pressure of the hoses in the first embodiment of the present invention (FIG. 2), in the second embodiment of the present invention (FIG. 6), in the third embodiment of the present invention (FIG. 7), and in the conventional structure (FIG. 9) is being maintained at a pressure of 1 kg/cm², the differences of the discharging flow rates are investigated, and the experiment results are as follows:

Results of Flow Rates After First Flow Flux Analysis (1 kg/cm²)

| | | Result Values of | |
|---|---|---|---|
| NO | Division | Flow Flux Analysis | Figure Number |
| 1 | First Embodiment | 0.94 Lit/Hr | FIG. 2 |
| 2 | Second Embodiment | 1.19 Lit/Hr | FIG. 6 |
| 3 | Third Embodiment | 1.48 Lit/Hr | FIG. 7 |
| 4 | Conventional Structure | 2~3 Lit/Hr | FIG. 9 (double |
| | | | tube type, |
| | | | teeth type, and |
| | | | maze type) |

*According to the flow flux analysis, the conventional structure flows water at a lateral side and has a longitudinally cut punching shape, and when compared with the embodiments of the present invention, the conventional structure has a relatively low pressure-reducing effect and has flow rate differentials with respect to respective units because the flow current is fast, such that it is difficult to measure accurate experimental data, but flow rate of about 2 to 3 liters is obtained.
*The above data are representative values and the flow rates may be different according to the bonding degrees of the hose.

From the above results, it is appreciated that at the same water pressure conditions (1 kg/cm²), the discharging flow rate is about 1 liters per hour in the pressure-reducing channels of the preferred embodiments of the present invention, but it is about 2 to 3 liters per hour in the teeth type or maze type of conventional structures, such that the pressure-reducing effects in the pressure-reducing channels of the preferred embodiments of the present invention are two to three times as good as those in the conventional structures.

In the pressure-reducing channel according to the present invention, therefore, even though the length of the inducing groove parts 12, 120 or 220 of this invention may be relatively shorter than that of the conventional practices, the same pressure-reducing effects as the conventional practices can be achieved. Thus, the plurality of unit pressure-reducing channels each having the inlet part 14, 140, or 240, the inducing groove part 12, 120, or 220, and the staying groove part 11, 110, or 210 can be advantageously disposed at narrower intervals than those in the conventional practices, and the reduction of the water pressure is mostly conducted through the inducing groove part 12, 120, or 220, not through the inlet part 14, 140, or 240, such that even though the hose is extended further, the water pressure acting at the inlet part 14, 140, or 240 of each unit pressure-reducing channel is almost the same as that at another inlet part. Consequently, a uniform quantity of water can be continuously supplied irrespective of the length of the hose H.

As discussed above, there is provided the drip irrigation hose according to the preferred embodiments of the present invention that is provided with the plurality of unit pressure-reducing channels each having the inlet part 14, the inducing groove part 12 and the staying groove part 11, the inducing groove part 12 having the plurality of flow passageways formed in such a manner as to be reduced and enlarged in turn in the width and the plurality of crescent-shaped protrusions 13 formed in the flow passageways enlarged in their width for reducing water pressure while colliding against the water flowing thereinto, such that water is effectively reduced in pressure while passing through the inducing groove part 12.

To conveniently implement the manufacturing process of the drip irrigation hose of this invention, the plurality of unit pressure-reducing channels each having the inlet part 14, the inducing groove part 12 and the staying groove part 11 are disposed at longitudinally-spaced locations along the length of the hose.

Therefore, the water flowing into the hose flows through the inlet part 14 of each of the plurality of unit pressure-reducing channels and flows to the inducing groove part 12 fluidically communicating with the inlet part 14, such that after the pressure of water is greatly reduced and the flowing speed is greatly low, the water stays in the staying groove part 11. Then, the water staying in the staying groove part 11 drops to plants through the outlet 2 on the hose H. According to the present invention, the irrigation uniformity coefficients are excellent with reference to the plants growing in a large area, at an expense of relatively low installation costs, without consuming any separate personnel costs, thereby achieving efficient water supply results, and further, the quantity of water and the power consumption costs are all reduced, thereby greatly improving the economic savings while growing the plants.

Additionally, since the plurality of unit pressure-reducing channels each including the inlet part 14, the inducing groove part 12 and the staying groove part 11 are disposed at longitudinally-spaced locations along the length of the hose H, water flowing into the inducing groove part 14 through the inlet part 14 is sufficiently reduced in pressure through the flow passageways thereof and drops to plants, and since the pressure drop of water is not almost generated until the water flows into the inlet parts 14 of the plurality of unit pressure-reducing channels, the water supplying state to each of the plurality of unit pressure-reducing channels is relatively uniform thereto even though the hose is long.

What is claimed is:

1. A drip irrigation hose comprising: a plurality of unit pressure-reducing channels each secured to the inner wall of the hose at longitudinally-spaced locations along a length of the hose in such a manner as to form an integrated type pressure-reducing channel; and a plurality of outlets for discharging water at longitudinally-spaced locations along the length of the hose, each of the plurality of unit pressure-reducing channels comprising an inlet part having a plurality of inlets formed at the left and right sides thereof, an inducing groove part connected to the inlet part and having a plurality of flow passageways formed in such a manner as to be reduced and enlarged in turn in the width thereof and a plurality of crescent-shaped protrusions formed in the flow passageways enlarged in the width thereof for reducing water pressure while the water flowing thereinto collides therewith, and a staying groove part connected to the inducing groove part and having a large space formed therein for making water flowing from the inducing groove part stay at stable pressure for a short time of period.

2. The drip irrigation hose according to claim 1, wherein the inlet part has a plurality of inlets formed at the side walls thereof, thereby having a filtering function of preventing the clogging of the hose.

3. The drip irrigation hose according to claim 1, wherein the structure of forming the plurality of flow passageways in the inducing groove part of each of the plurality of unit pressure-reducing channels enables the length of each unit pressure-reducing channel to be greatly reduced, and even in this case, uniform irrigation coefficients are obtained from each unit pressure-reducing channel.

4. The drip irrigation hose according to claim 1, wherein the water flowing through the plurality of inlets from the inlet part forms turbulent flow and is reduced in pressure while passing through the plurality of flow passageways formed in reduced and enlarged in turn in the width thereof, and at this time, the water collides with the plurality of crescent-shaped protrusions to facilitate the formation of turbulent flow, such that when the water colliding with the plurality of crescent-shaped protrusions is mixed with the water that does not collide therewith, another turbulent flow is formed.

5. The drip irrigation hose according to claim 1, wherein the inducing groove part is formed by connecting the square flow passageways enlarged in width with the flow passageways reduced drastically in width in such a manner as to be gently enlarged in width from the inlet to the outlet, such that the plurality of flow passageways each having a crescent shape are connected to one another along the length of the hose and the plurality of protrusions are formed in the plurality of flow passageways of the crescent shapes.

6. The drip irrigation hose according to claim 1, wherein the water flowing into the flow passageways enlarged in the width thereof is divided into two flow streams by the formation of the protrusions in the middle portions of the flow passageways and is mixed at the rear side thereof, such that the water having the same speed flowing from the opposite directions to each other collides at the mixing, momentarily stops the flowing, and is discharged through the flow passageways reduced in the width thereof.

7. The drip irrigation hose according to claim 1, wherein the inducing groove part is formed in such a manner as to be reduced and enlarged in turn in the width thereof by the formation of a plurality of protrusions disposed at equally-spaced locations along the length of the hose, and the plurality of protrusions are arranged to left and right sides in turn to form a maze-like arrangement, each of the protrusions having a round head-like protrusion formed in the middle portion thereof for generating turbulent flow when water collides therewith.

8. The drip irrigation hose according to claim 1, wherein the plurality of unit pressure-reducing channels are integrally connected to the inner wall of the hose along the entire length of the hose.
